(19) United States
(12) Patent Application Publication
(10) Pub. No.: US 2005/0265204 A1
(43) Pub. Date: Dec. 1, 2005

(54) Optical head device

(76) Inventor: Hiroshi Sakai, Suwa-gun (JP)

Correspondence Address: Eugene LeDonne, Esq.,;Reed Smith LLP, 29th Floor, 599 Lexington Avenue, New York, NY, 10022, US

(21) Appl. No.: 11/116,060

(22) Filed: Apr. 27, 2005

(30) Foreign Application Priority Data
Apr. 28, 2004 (JP) JP 2004-134290

(51) Int. Cl. G11B 7/00; G11B 7/135

(52) U.S. Cl. 369/112.03; 369/112.01; 369/44.12

(57) ABSTRACT

An optical head device for performing at least one of recording and reproduction of information on and from an optical recording disk provided with two or more recording layers includes a laser beam emitting element as a light source and a diffraction element for forming a main beam comprising of a zero-order light beam and sub-beams comprising of (±) first order light beams from a laser beam that is emitted from the laser beam emitting element. The diffraction ratio of the zero-order light beam, the (+) first order light beam and the (−) first order light beam in the diffraction element is set to be from about 8:1:1 to about 18:1:1.

### CROSS-REFERENCE TO RELATED APPLICATIONS

This application claims priority to Japanese Application No. 2004-134290 filed Apr. 28, 2004, which is incorporated herein by reference.

### FIELD OF THE INVENTION

The present invention relates to an optical head device for recording or reproducing information on or from an optical recording disk such as a DVD-R/RW that is provided with a recording layer having two or more recording layers.

### BACKGROUND OF THE INVENTION

In a drive device for an optical recording disk such as a CD-R and a DVD-R/RW, the Differential Push-Pull (DPP) method is used to perform a tracking servo. In this DPP method, output signals in respective light receiving elements which are respectively obtained from a main beam and two sub-beams (side beam) are calculated to generate a tracking error signal. In other words, a diffraction grating is mounted on a forward path of a beam that is emitted from a laser beam emitting element and respective beam spots of three light beams, which are comprised of a zero-order diffracted light (main beam) and two first order diffracted lights (± first order diffracted sub-beams) are formed on the optical recording disk through a collimator lens and an objective lens. The return light beams are received by respective light receiving elements. Then, a Main Push-Pull (MPP) signal is generated from the output signal of a main light receiving face and a Sub Push-Pull/Side Push-Pull (SPP) signal is generated from the output signals of respective sub-light receiving faces. These signals are calculated in a prescribed equation to obtain a tracking error signal.

When recording is performed on an optical recording disk, it is required to ensure the light quantity that is effective for recording. Therefore, the diffraction element is constructed such that the light quantity of the main beam is increased as much as possible and the light quantity of the sub-beams is decreased. In this way, the efficiency of high multiple speed recording and the laser beam emitting element is increased.

As shown in FIG. 1, a single optical recording disk 1 has been known in the art that is provided with a recording layer 2 having two or more recording layers to remarkably enhance recording density. In this case, when the recording layer 2 that is closer to the surface of the optical recording disk 1 is defined as a zero layer 20 and the recording layer 2 that is on the far side from the surface of the optical recording disk 1 is defined as a first layer 21, the reflection factor of the zero layer 20 is set to be about 30% and the remainder is transmitted to reach the first layer 21. On the other hand, the first layer 21 is constructed such that the reflection factor becomes the maximum.

However, in the case that the recording is performed on the optical recording disk, when the DPP method is used in a conventional optical head device, a tracking error signal cannot be accurately obtained. The reason is considered as follows. When a focusing servo is performed on the zero layer 20, about 60% of the laser beam is transmitted through the zero layer 20 as described above and reaches the first layer 21. In this case, when the light quantity of the main beam is large, the main beam reflected by the first layer 21 reaches the light receiving element 140 as a divergent light beam. The light quantity of the main beam that is reflected by the first layer 21 and reaches a light receiving face for sub-beam of the light receiving element 140 becomes equal to or more than the light quantity of primary sub-beams which are reflected by the zero layer 20 and reach the light receiving face for sub-beam, and thus the tracking error signal is not accurately obtained.

### SUMMARY OF THE INVENTION

In view of the problems described above, it is an object and advantage of the present invention to provide an optical head device that is capable of accurately obtaining a tracking error signal even when two or more recording layers are formed in one optical recording disk.

In order to achieve the above object and advantage, according to an embodiment of the present invention, there is provided an optical head device for performing at least one of recording and reproduction of information on and from an optical recording disk provided with two or more recording layers including a laser beam emitting element as a light source and a diffraction element for forming a main beam comprising of a zero-order light beam and sub-beams comprising of (±) first order light beams from a laser beam which is emitted from the laser beam emitting element. The diffraction ratio of the zero-order light beam, the (+) first order light beam and the (−) first order light beam in the diffraction element is set to be from about 8:1:1 to about 18:1:1 (zero-order light beam: (+) first order light beam: (−) first order light beam).

In accordance with an embodiment of the present invention, the diffraction ratio of the zero-order light beam, the (+) first order light beam and the (−) first order light beam in the diffraction element is set to be from about 8:1:1 to about 18:1:1. In other words, the light quantity of the main beam is restrained lower in comparison with the conventional diffraction ratio. Therefore, in the case that a focusing servo is performed on the recording layer that is closer to the surface in the optical recording disk, even when the main beam reflected by the far side of the recording layer from the surface of the optical recording disk reaches a light receiving element as a divergent light beam, the light quantity of the main beam that is reflected by the far side recording layer and reaches a sub-light receiving face is restrained in a lower level and negligible in comparison with the light quantity that is reflected by the near side recording layer and reaches the sub-light receiving face. Consequently, the return light beam of the main beam that is reflected by the far side recording layer does not obstruct the generation of the tracking error signal. In addition, since the lower limit to the ratio of the zero-order light beam (main beam) is also set, and thus the recording efficiency is not reduced.

According to the embodiment of the present invention, it is further effective when the present invention is applied to an optical head device in which at least recording is performed on the optical recording disk. When recording is conventionally performed on an optical recording disk, the light quantity of the main beam is increased as much as possible to ensure that the light quantity is effective for recording. According to the embodiment of the present invention, since the upper limit to the ratio of the zero-order light beam (main beam) is also set, the tracking error signal can be accurately obtained when recording is performed.

According to the embodiment of the present invention, when a focusing servo is performed on the near side recording layer that is closer to the surface of the optical recording disk, the return light beam of the main beam reflected by the far side recording layer that is far away from the surface of the optical recording disk does not reach the sub-light receiving face with a high degree of light quantity. Consequently, it is further effective when the present invention is applied to an optical head device in which a tracking servo is performed by using a Differential Push-Pull (DPP) method in which a tracking error signal is generated by calculating the light receiving result of the return light beam of the main beam and the sub-beams from the optical recording disk.

Further, it is further effective when the present invention is applied to an optical head device in which the optical recording disk has a two layers construction in which the closer side recording layer of the optical recording disk is defined as the zero layer and the far side recording layer of the optical recording disk is defined as the first layer, and the optical recording disk is constructed such that the reflection factor of the zero layer is set to be about 30% and the reflection factor of the first layer is set to be the maximum.

According to the present invention, the diffraction ratio of the zero-order light beam, the (+) first order light beam and the (−) first order light beam in the diffraction element is set to be from about 8:1:1 to about 18:1:1. In other words, the light quantity of the main beam is restrained lower in comparison with the conventional diffraction ratio. Therefore, in the case that a focusing servo is performed on a recording layer that is closer to the surface in the optical recording disk, the light quantity of the main beam that is reflected by the far side recording layer and reaches a sub-light receiving face is restrained in a lower level and negligible in comparison with the light quantity that is reflected by the near side recording layer and reaches the sub-light receiving face. Consequently, the return light beam of the main beam that is reflected by the far side recording layer does not obstruct the generation of the tracking error signal. In addition, the return light beam of the main beam that is reflected by the far side recording layer does not obstruct the generation of the tracking error signal and thus the tracking error signal can be accurately obtained even when two or more recording layers are formed on a single optical recording disk. Further, since the lower limit to the ratio of the zero-order light beam (main beam) is also set, the recording efficiency is not reduced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a schematic construction view showing the basic construction of an optical head device in accordance with an embodiment of the present invention.

FIG. 2 is a graph showing the relative efficiency and the modulation ratio of a zero-order light beam when the diffraction ratio of the zero-order light beam, a (+) first-order light beam and a (−) first-order light beam in a diffraction element is changed in the optical head device.

FIG. 3 is a graph showing changes of the ratio of SPP offset inside and outside difference with respect to an inner peripheral SPP amplitude when the absolute value of SPP offset inside and outside difference is changed in the optical head device.

### DETAILED DESCRIPTION OF THE PREFERRED EMBODIMENTS

Embodiments of the present invention will be described below with reference to the accompanying drawings.

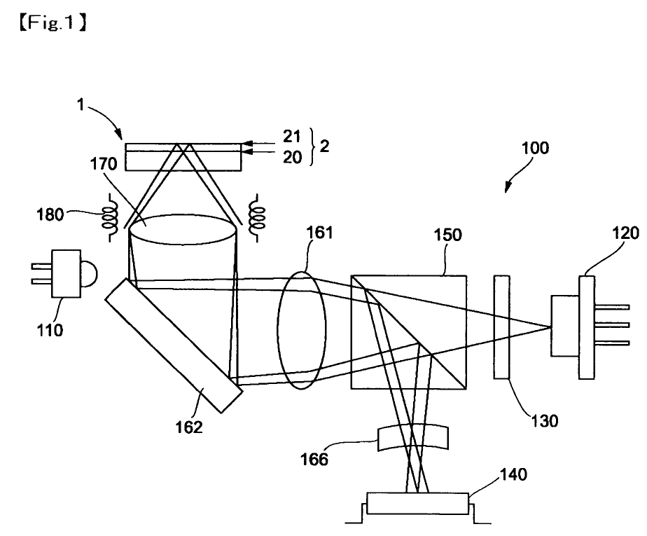

FIG. 1 is a schematic construction view showing the basic construction of an optical head device to which the present invention is applied.

An optical head device 100 shown in FIG. 1 is used to perform recording and reproduction of information on and from an optical recording disk 1 such as a DVD-R/RW which is provided with a recording layer 2 having two or more recording layers (zero layer 20 and first layer 21). The optical system of the optical head device 100 includes a laser beam emitting element 120 as a light source which emits a short wavelength laser light beam near a wavelength of 630 nm or 635 nm, a diffraction element 130 for splitting the laser light beam emitted from the laser beam emitting element 120 into three beams, i.e., a zero-order light beam (main beam) and (±) first order light beams (two sub-beams), a prism 150 for optical path separation, a collimating lens 161 for converting the laser beam transmitted through the prism 150 into a parallel light beam, a raising mirror 162 for deflecting the parallel light beam emitted from the collimating lens 161 in a predetermined direction, and an objective lens 170 for converging the parallel light beam which is deflected by the raising mirror 162 on the optical recording disk 1. These optical elements are disposed in this order to construct an optical path (forward path) ranging from the laser beam emitting element 120 to the optical recording disk 1.

A sensor lens 166 and a light receiving element 140 for signal detection are disposed on a side of the prism 150. The return light beam that is reflected by the optical recording disk 1 is incident on the prism 150 through the objective lens 170, the raising mirror 162 and the collimating lens 161. Then, the return light beam is bent in an orthogonal direction by the prism 150 so as to be guided to the sensor lens 166 and the light receiving element 140. In this manner, an optical path (return path) of the return light beam is constructed from the optical recording disk 1 to the light receiving element 140. The sensor lens 166 generates astigmatism in the return light beam from the optical recording disk 1 and increases the magnifying power of the return light beam.

The optical head device 100 in accordance with the embodiment of the present invention is constructed to obtain a tracking error signal by the DPP method to perform a tracking servo. Therefore, in the light receiving element 140 for signal detection, a main light receiving face (MPD) for receiving the return light beam (main spot) of the main beam is divided into four pieces longitudinally and laterally, and sub-light receiving faces (SPD) for receiving the return light beam (sub spot) of the sub-beam are respectively divided into two pieces in the longitudinal direction. Accordingly, the main push-pull (MPP) signal is generated from the output signal in the main light receiving face and the sub push-pull (SPP) signal is generated from the output signals in the respective sub-light receiving faces. The tracking error signal is obtained by calculating these signals in a predetermined equation.

The optical head device 100 is provided with a light receiving element 110 for monitor behind the raising mirror 162. The light receiving element 110 receives a laser light beam deviated from the raising mirror 162. The result that is obtained by receiving a light beam in the light receiving element 110 is fed back to the laser beam emitting element 120 to control the emitting level of the laser beam emitting element 120.

The optical head device 100 is provided with a lens drive device 180 for driving the objective lens 170 in a focusing direction and a tracking direction. The lens drive device 180 includes a tracking drive coil, a tracking driving magnet, a focusing drive coil, a focusing driving magnet and the like. However, their constructions are well known and thus their detailed descriptions are omitted.

In the optical head device 100 constructed as described above, the optical recording disk 1 is formed with two recording layers 2 on a common base material to enhance its recording density. In this case, when the recording layer 2 that is closer to the surface of the optical recording disk 1 is defined as a zero layer 20 and the recording layer 2 that is on the far side from the surface of the optical recording disk 1 is defined as a first layer 21, the reflection factor of the zero layer 20 is set to be about 30% and the remainder is transmitted to reach the first layer 21. The first layer 21 is constructed such that the reflection factor becomes the maximum. Therefore, when a focusing servo is performed on the zero layer 20 to perform recording on the zero layer 20 of the optical recording disk 1, about 60% of the laser beam is transmitted through the zero layer 20 and reaches the first layer 21. In this case, the main beam reflected by the first layer 21 reaches the light receiving element 140 as a divergence light beam. However, in the embodiment of the present invention, as described below, the height of grating of the diffraction element 130 is set such that the diffraction ratio of a zero-order light beam, a (+) first order light beam and a (−) first order light beam in the diffraction element 130 is from about 8:1:1 to about 18:1:1. In other words, the diffraction ratio of [(zero-order light beam) : ((+) first order light beam) : ((−) first order light beam)] is set to be from about (8:1:1) to about (18:1:1). Therefore, the light quantity of the main beam which is reflected by the first layer 21 and reaches the sub-light receiving faces of the light receiving element 140 becomes significantly smaller in comparison with the light quantity of the sub-beams which are reflected by the zero layer 20 and reach the sub-light receiving faces of the light receiving element 140, and thus it can be ignored. Consequently, the return light beam of the main beam reflected by the first layer 21 does not obstruct the generation of the tracking error signal.

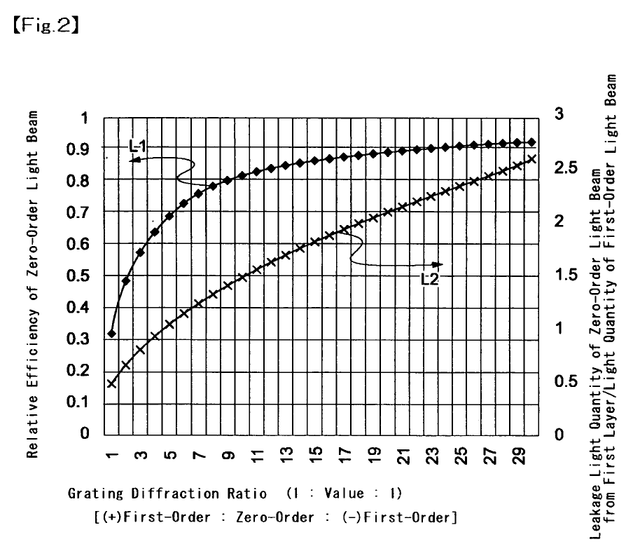

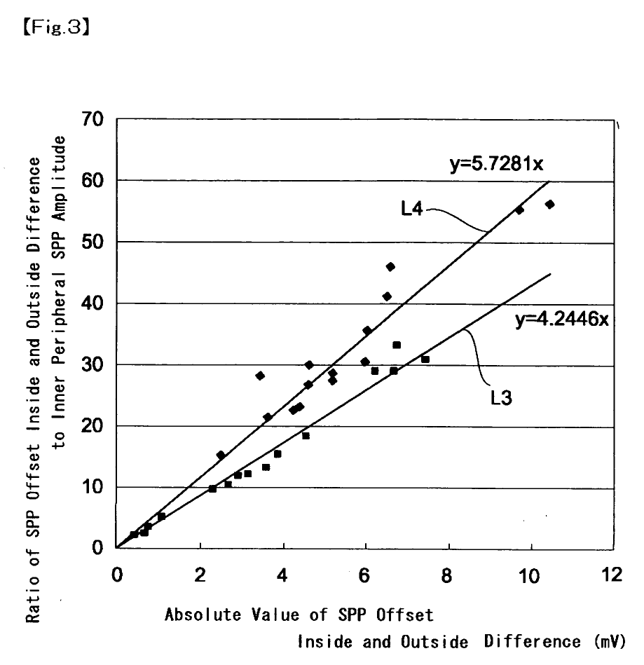

The construction in accordance with the embodiment of the present invention is described in detail with reference to FIGS. 2 and 3. FIG. 2 is a graph showing the relative efficiency and the modulation ratio (leakage light quantity of zero-order light beam from the first layer 21/light quantity of first order light beam) of the zero-order light beam when the diffraction ratio of the zero-order light beam, the (+) first-order light beam and the (−) first-order light beam in the diffraction element 130 is changed. In FIG. 2, the relative efficiency of the zero-order light beam is shown by the solid line L1 and the modulation ratio is shown by the solid line L2. FIG. 3 is a graph showing changes of the ratio of SPP offset inside and outside difference with respect to an inner peripheral SPP amplitude where the absolute value of SPP offset inside and outside difference is changed in an example of the present invention in which the diffraction ratio of the zero-order light beam, the (+) first order light beam and the (−) first order light beam in the diffraction element 130 is set to be (15:1:1) and in a comparison example in which the diffraction ratio of the zero-order light beam, the (+) first order light beam and the (−) first order light beam in the diffraction element 130 is set to be (21.75:1:1). In FIG. 3, the example of the present invention is shown by the solid line L3 and the comparison example is shown by the solid line L4. The SPP offset inside and outside difference means the difference of SPP offsets that are generated in the inner peripheral side and the outer peripheral side of the optical recording disk 1. When the optical recording disk 1 is warped and there is a difference in the tilt between the inner peripheral side and the outer peripheral side of the recording layer 2, the difference of the SPP offsets occurs between the inner peripheral side and the outer peripheral side of the optical recording disk 1.

As shown in FIG. 2, in the case that the diffraction ratio of the zero-order light beam, the (+) first order light beam and the (−) first order light beam in the diffraction element 130 is changed, when the ratio of the zero-order light beam is increased more than (18:1:1) as shown by the solid line L2 in the diffraction ratio of the zero-order light beam, the (+) first order light beam and the (−) first order light beam in the diffraction element 130, the leakage light quantity (modulation ratio) exceeds the value of two. In other words, when the ratio value of the zero-order light beam is increased more than 18 while those of the (+) first order light beam and the (−) first order light beam remain 1 as shown by the solid line L2, the leakage light quantity exceeds the value of two. That is, the leakage light quantity of the zero-order light beam from the first layer 21 exceeds the light quantity of the first order light beam and the affection of the leakage light quantity of the zero-order light beam from the first layer 21 becomes larger, and thus an accurate tracking servo cannot be performed. Therefore, the diffraction ratio of the zero-order light beam, the (+) first order light beam and the (−) first order light beam in the diffraction element 130 is preferable that the ratio of the zero-order light beam is lower than (18:1:1). In other words, it is preferable that the ratio value of the zero-order light beam is lower than 18 while those of the (+) first order light beam and the (−) first order light beam are respectively 1.

As shown by the solid line L1 in FIG. 2, when the ratio of the zero-order light beam is increased larger than the diffraction ratio, i.e., (8:1:1) of the zero-order light beam, the (+) first order light beam and the (−) first order light beam in the diffraction element 130, the relative efficiency of the zero-order light beam increases gradually. In other words, when the ratio value of the zero-order light beam is increased more than 8 while those of the (+) first order light beam and the (−) first order light beam remain 1, the relative efficiency of the zero-order light beam increases gradually as shown by the solid line L1. However, when the ratio of the zero-order light beam is decreased lower than the diffraction ratio, i.e., (8:1:1) of the zero-order light beam, the (+) first order light beam and the (−) first order light beam in the diffraction element 130, the relative efficiency of the zero-order light beam rapidly decreases, and thus it is unfavorable. Therefore, in the embodiment of the present invention, the diffraction ratio of the zero-order light beam, the (+) first order light beam and the (−) first order light beam in the diffraction element 130 is set to be from about (8:1:1) to about (18:1:1). As a result, both accurate tracking servo and efficient recording can be realized.

In FIG. 3, the ratio of SPP offset inside and outside difference in accordance with the embodiment of the present invention is shown by the solid line L3, in which the diffraction ratio of the zero-order light beam, the (+) first order light beam and the (−) first order light beam in the diffraction element 130 is set to be (15:1:1). According to the embodiment shown by the solid line L3, the ratio of SPP offset inside and outside difference is smaller and stable. On the other hand, in FIG. 3, the ratio of SPP offset inside and outside difference in the comparison example is shown by the solid line L4, in which the diffraction ratio of the zero-order light beam, the (+) first order light beam and the (−) first order light beam in the diffraction element 130 is set to be (21.75:1:1). In the comparison example, the ratio of SPP offset inside and outside difference is larger and not stable.

As described above, in the optical head device 100 in accordance with the embodiment of the present invention, the diffraction ratio of the zero-order light beam (main beam), the (+) first order light beam (sub-beam) and the (−) first order light beam (sub-beam) in the diffraction element 130 is set to be from about (8:1:1) to about (18:1:1). In other words, the light quantity of the main beam is restrained to be in a lower level in comparison with the conventional diffraction ratio. Therefore, in the case that a focusing servo is performed on the recording layer 2 (zero layer 20) that is closer to the surface in the optical recording disk 1, even when the main beam reflected by the recording layer 2 (first layer 21) that is on the far side from the surface reaches the light receiving element 140 as a divergent light beam, the light quantity of the main beam that is reflected by the first layer 21 and reaches the sub-light receiving face is restrained in a lower level and negligible in comparison with the light quantity that is reflected by the zero-level layer 20 and reaches the sub-light receiving face. Consequently, in the optical head device 100 in accordance with the embodiment of the present invention, the return light beam of the main beam that is reflected by the first layer 21 does not obstruct the generation of the tracking error signal and thus the tracking error signal can be accurately obtained even when two or more recording layers are formed on one optical recording disk 1. In addition, since the lower limit to the ratio of the zero-order light beam (main beam) is also set, the recording efficiency is not reduced.

In the embodiment described above, the case of recording on the optical recording disk 1 in the optical head device 100 is described, but the reproduction from the optical recording disk 1 is performed in a similar manner. Therefore, the present invention can be applied to an optical head device such as an optical head device performing both recording and reproduction, an optical head device only for recording, and an optical head device only for reproduction when the optical head device 100 is constructed so as to perform at least one of recording and reproduction of information to or from the optical recording disk 1 provided with two or more recording layers 2.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An optical head device for performing at least one of recording and reproduction of information on and from an optical recording disk provided with two or more recording layers comprising:
a laser beam emitting element as a light source; and
a diffraction element for forming a main beam comprising of a zero-order light beam and sub-beams comprising of (±) first order light beams from a laser beam that is emitted from the laser beam emitting element,
wherein the diffraction ratio of the zero-order light beam, the (+) first order light beam and the (−) first order light beam in the diffraction element is set to be from about 8:1:1 to about 18:1:1.

2. The optical head device according to claim 1, wherein at least the recording is performed on the optical recording disk.

3. The optical head device according to claim 1, wherein a tracking servo is performed by using a differential push-pull method in which a tracking error signal is generated by calculating a light receiving result of a return light beam of the main beam and the sub-beams from the optical recording disk.

4. The optical head device according to claim 1, wherein the optical recording disk has a two layers construction in which a near side recording layer of the optical recording disk is defined as a zero layer and a far side recording layer of the optical recording disk is defined as a first layer, and the optical recording disk is constructed such that a reflection factor of the zero layer is set to be about 30% and a reflection factor of the first layer is set to be the maximum.

5. An optical head device for performing at least one of recording and reproduction of information on and from an optical recording disk having at least two recording layers, the optical head device comprising:
a laser beam emitting element as a light source; and
a diffraction element for splitting a laser beam emitted from the laser beam emitting element into a main beam comprising of a zero-order light beam and sub-beams comprising of (±) first order light beams,
wherein the diffraction ratio of the zero-order light beam, the (+) first order light beam and the (−) first order light beam in the diffraction element is set to be from about 8:1:1 to about 18:1:1.
